(19) United States
(12) Patent Application Publication
(10) Pub. No.: US 2015/0065792 A1
(43) Pub. Date: Mar. 5, 2015

(54) HAND-OPERATED MALE MASTURBATION DEVICE

(71) Applicant: Anthony H. LEVINE, Woodland Hills, CA (US)

(72) Inventor: Anthony H. LEVINE, Woodland Hills, CA (US)

(21) Appl. No.: 14/011,054

(22) Filed: Aug. 27, 2013

(51) Int. Cl. A61H 19/00

(52) U.S. Cl. CPC A61H 19/30
USPC 600/38

(57) ABSTRACT

A device for male masturbation comprising an open-ended design to eliminate the suction force attributed to closed-end masturbation devices. The device utilizes a holding frame and attachable flexible tubular members. The holding frame is hinged to allow for adjustment of pressure against the penis or can be completely closed for hands-free operation. The flexible tubular members are held in contact with a user's penis by compressing the holding frame. The holding frame facilitates expansion of the flexible tubular members when the device is under compression by incorporating arched recesses. Because no adhesives are used to connect the holding frame and flexible tubular members, the device can be easily assembled, disassembled, and cleaned.

### CROSS-REFERENCE TO RELATED APPLICATION

This present application claims the benefit of Provisional Application Number 61/695,950 filed Aug. 31, 2012. The prior application is incorporated herein by reference.

### FEDERALLY SPONSORED RESEARCH

Not Applicable

### SEQUENCE LISTING OR PROGRAM

Not Applicable

### BACKGROUND

“Masturbation,” or the sexual stimulation of one's own genitals, is frequent among humans of both sexes and age groups. It is believed that masturbation can provide medical and psychological benefits and is widely considered to be a normal part of healthy life. Currently there are numerous devices available to aid with performing masturbation. For men, many of the devices incorporate fluid filled members that surround the penis so that there is no direct hand contact between the user and penis. Such devices are manipulated in an up and down direction along the length of the penis. Others are merely openings in various objects for insertion of the penis, such openings are made of soft material and often human in appearance. Although current devices allow for masturbation without direct hand contact, they do not provide a sensation similar enough to actual penetration.

The current devices to aid with performing masturbation not only lack a sensation similar enough to actual penetration, they suffer from the additional disadvantages of being complicated to manufacture, and inconvenient to disassemble and clean. For the foregoing reasons, there is a need for a male masturbation device that can provide a sensation more similar to actual penetration, is hygienic and easily cleaned, can be easily and reliably manufactured, and is capable of being heated in a microwave and cooled in a freezer.

### SUMMARY

The present invention is directed to a device that satisfies the need for a male masturbation device that can provide a sensation more similar to actual penetration, is hygienic, easily cleaned, can be easily and reliably manufactured, and is capable of being heated in a microwave and cooled in a freezer. The device comprises a relatively hard holding frame and flexible tubular members made of relatively flexible material filled with water, liquids, foam, gels or other suitable materials. The holding frame is preferably made in one piece and consists of an elongated semi tubular member with concaved walls that is capable of being folded at its mid-point and the opposite ends connected to one another to form a closed frame with the concaved walls of the tubular member facing one another. The holding frame member has holes through its concaved surfaces for receiving projections that extend from the flexible tubular members. The flexible tubular members attach to the holding frame holes by projections that terminate in mushroom-shaped ends. Although the preferred embodiment comprises a pair of flexible tubular members, a single donut-shaped flexible tube may also be used.

Because the present invention incorporates a simple design and very few parts, it is easy to manufacture. The manner in which the flexible tubular members attach to the holding frame allows the device to be easily cleaned whether assemble or disassembled. Moreover, the materials and shape utilized for the holding member and flexible tubular members allow the device to be safely heated by microwave or cooled in the freezer, will maintain structural integrity, and provide a more pleasurable experience.

### DRAWINGS

FIG. 1 illustrates a top perspective view of a device embodying features of the present invention for a hand-operated male masturbation device with a holding frame and flexible tubular members.

FIG. 2 illustrates a front elevation view of a device embodying features of the present invention for a hand-operated male masturbation device.

FIG. 3 illustrates a left side elevation view of a device embodying features of the present invention for a hand-operated male masturbation device, the right side appears the same.

FIG. 4 illustrates a back elevation view of a device embodying features of the present invention for a hand-operated male masturbation device.

FIG. 5 illustrates a top view of a device embodying features of the present invention for a hand-operated male masturbation device.

FIG. 6 illustrates a right side elevation view of a device embodying features of the present invention for a hand-operated male masturbation device.

FIG. 7 illustrates a bottom view of a device embodying features of the present invention for a hand-operated male masturbation device.

FIG. 8 illustrates a perspective view of an open holding frame embodying features of the present invention for a hand-operated male masturbation device.

FIG. 9 illustrates a perspective view of an closed holding frame embodying features of the present invention for a hand-operated male masturbation device.

FIG. 10 illustrates a top perspective view of a smooth flexible tubular member embodying features of the present invention for a hand-operated male masturbation device.

FIG. 11 illustrates a left side elevation view of a smooth flexible tubular member embodying features of the present invention for a hand-operated male masturbation device, the right side appears the same.

FIG. 12 illustrates a front elevation view of a smooth flexible tubular member embodying features of the present invention for a hand-operated male masturbation device, the back appears the same.

FIG. 13 illustrates a top perspective view of a bumpy flexible tubular member embodying features of the present invention for a hand-operated male masturbation device.

FIG. 14 illustrates a left side elevation view of a bumpy flexible tubular member embodying features of the present invention for a hand-operated male masturbation device, the right side appears the same.

FIG. 15 illustrates a front elevation view of a bumpy flexible tubular member embodying features of the present invention for a hand-operated male masturbation device, the back appears the same.

FIG. 16 illustrates a top perspective view of a ridged flexible tubular member embodying features of the present invention for a hand-operated male masturbation device.

FIG. 17 illustrates a left side elevation view of a ridged flexible tubular member embodying features of the present invention for a hand-operated male masturbation device, the right side appears the same.

FIG. 18 illustrates a front elevation view of a ridged flexible tubular member embodying features of the present invention for a hand-operated male masturbation device, the back appears the same.

FIG. 19 illustrates an alternative embodiment of a flexible tubular member embodying features of the present invention for a hand-operated male masturbation device, the right side appears the same.

### DESCRIPTION

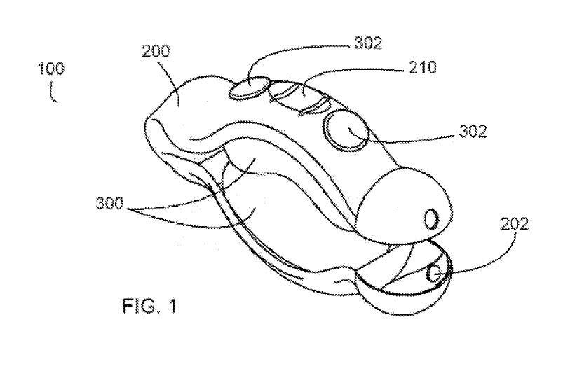

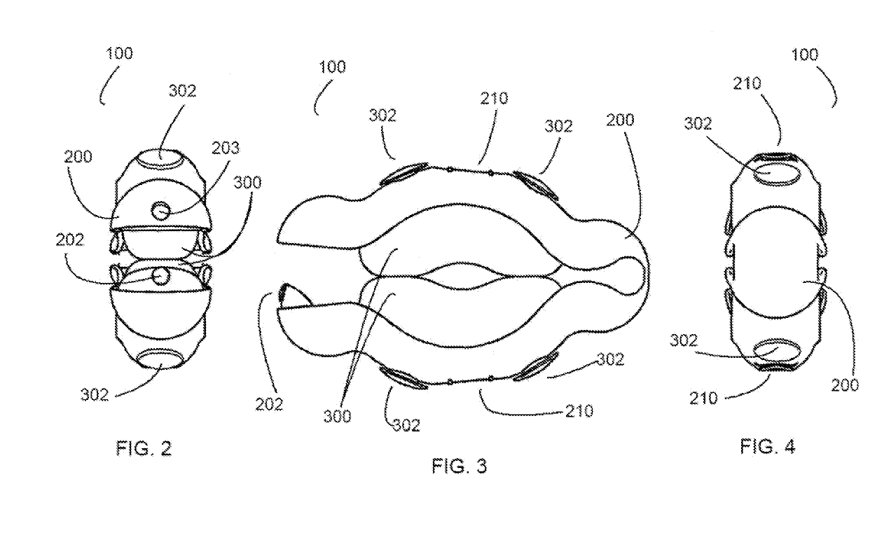

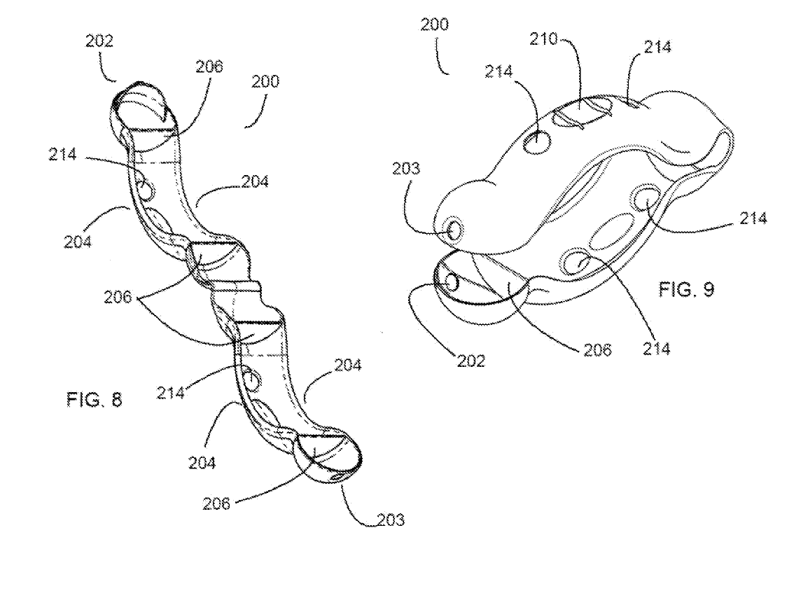

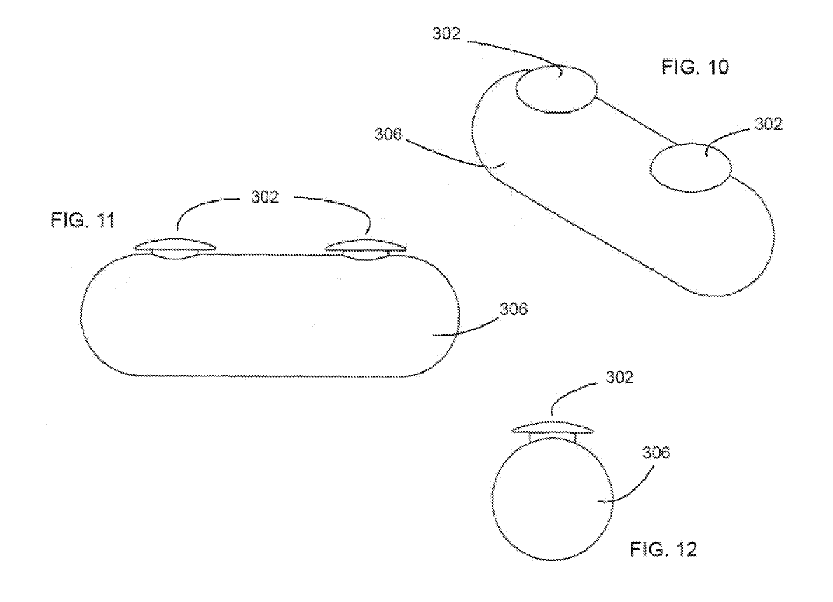

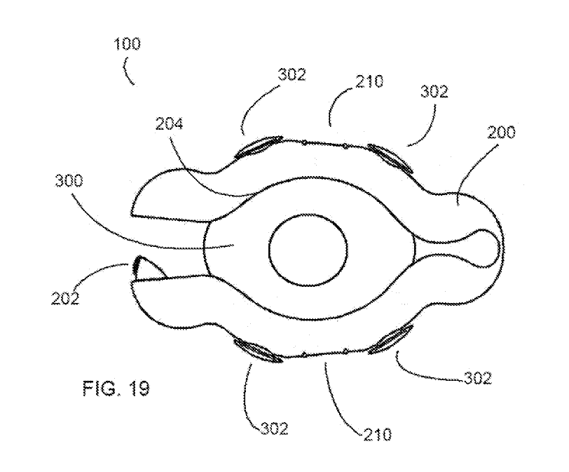

As shown in FIGS. 1-19, a hand-operated male masturbation device 100 comprises a holding frame 200 and several flexible tubular members 300 affixed within and surrounded by the holding frame 200. This simple, 3-piece construction allows for easy manufacturing and a production lower cost. The holding frame 200, illustrated in FIG. 1, is shaped like an elongated semi-tubular member that is hinged so that the opposite ends are connected to one another forming a closed frame with the concaved portions of the tubular member facing one another. Referring to FIGS. 8-9, the holding frame 200 can be made of a material such as semi-rigid polypropylene, and may be constructed from a single piece folded at its mid-point or from two pieces connected by a hinge. Referring to FIGS. 10-18, the flexible tubular members 300 are shaped like cylinders with rounded ends and projections 302 so that they may be affixed within the holding frame 200. Alternatively, the flexible tubular member 300 may be formed as a donut-shaped flexible tube as illustrated in FIG. 19. The flexible tubular members 300 can be made of a material such as thermoplastic resin and filled with a variety of fluids or materials to achieve a desired sensation.

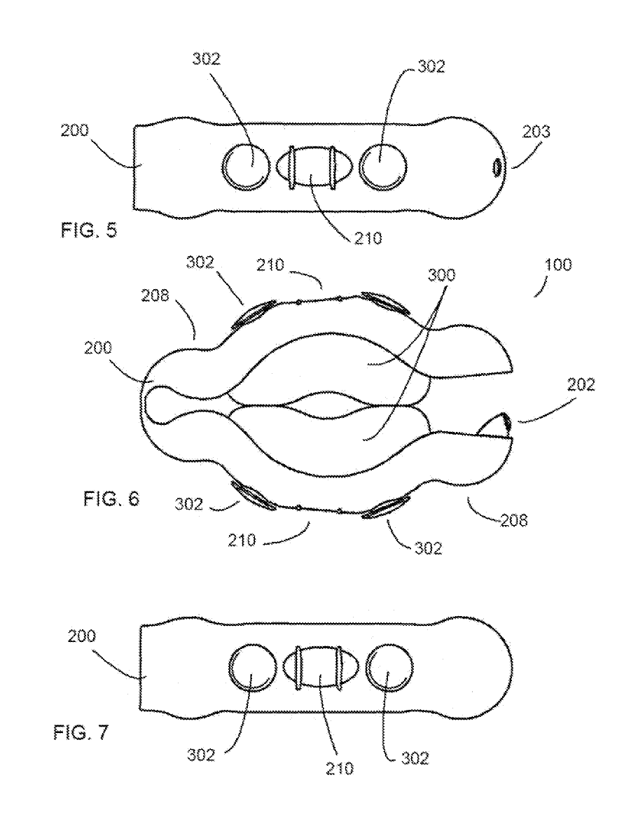

The hinged semi-tubular holding frame 200, as illustrated in FIGS. 1-9, functions to hold the flexible tubular members 300 in place and allows the user to vary the pressure to the penis by squeezing the holding frame 200 together. When the holding frame 200 is closed using the snap closure 202 and snap closure hole 203, the user has the option to slide directly into the device, isolating any sensation of the user using their own hands and providing the feeling of another persons touch. Alternatively, a rubber band may be wrapped around the double ball ends 208, as best illustrated in FIG. 6, to keep the hand-operated male masturbation device 100 at the desired level of closure.

The holding frame 200 incorporates arched recesses 201 with flared edges as best illustrated in FIGS. 8-9. The arched recesses 201 allow for expansion of the flexible tubular members 300 while the device is under compression. The arched recesses 201 guide the flexible tubular members 300 to expand in such a way that the channel/length of the contact area becomes longer and encompass more of the length of the penis. Referring to FIG. 6, the arched recesses 201 further cause the flexible tubular members 300 to touch at each end, maximizing the amount of compression on the penis, which would not occur if the flexible tubular members 300 were straight or not allowed to touch in this manner. The holding frame 200 flared edges increase structural integrity to minimize flex in the holding frame 200. If the holding frame 200 flexes or twists, the flexible tubular members 300 will have a tendency to detach or distort. Flex or distortion will reduce the gap between the penis and device, causing reduced sensation and possible undesired contact between the holding frame 200 and penis.

Internal ribs 206, as best illustrated in FIGS. 8-9, are integrated into the holding frame 200. The internal ribs 206 prevent the holding frame 200 sides from expanding outward when the flexible tubular members 300 are under compression and expand to the sides. Moreover, the internal ribs 206, help the holding frame 200 remain maintain its shape when exposed to heat, cooling, and continuous usage, assuring the device remains closed and pressure maximized on the penis.

Finger recesses 210, as best illustrated in FIGS. 5-7, are incorporated into the top and bottom of the holding frame 200. These ergonomically shaped finger recesses 210 facilitate better control of device motion and grip. The finger recesses 210 are centered on the holding frame 200 to allow use by either left or right hand. The finger recesses 210 also provide a partial flat surface that allows stabilization of the unit if used on a table or countertop. When closed, the holding frame 200 forms double ball ends 208 that allows for the use of a strap or elastic band to help keep the device closed if the user's penis diameter is such that the device cannot be closed using the snap closure 202. The double ball ends 208 also provide a grip location for two-handed use of the device.

The holding frame 200 has holes 214, illustrated in FIGS. 8-9, allowing for installation of the flexible tubular members 300. The holes 214 comprise rounded internal edges to prevent mold flashing during manufacturing, which could potentially cut into projections 302 on the flexible tubular members 300. Now referring to FIG. 1, the flexible tubular members 300 are retained in the holding frame 200 by passing the projections 302 on the flexible tubular members 300 through the holes. The projections 302, with mushroom-shaped ends, prevent undesired detachment of the flexible tubular members 300 from the holding frame 200. The length of the projections 302 provides a gap between the holding frame 200 and tubular members 300 to allow for tube expansion during use and easy cleaning when not in use. Normal water flow from a faucet will clean the device without removal of the tubes from the housing due to this gap.

FIGS. 10-19 illustrate the flexible tubular members 300. The preferred material for construction of the flexible tubular members 300 is thermoplastic resin because it does not leave a residue on surfaces like materials used in current devices. Moreover, the thermoplastic resin has a higher tear strength and resistance to lubricants. The flexible tubular members 300 can be filled with various fluids or materials, proving a variety of densities, textures and sensations. For example, the flexible tubular members 300 may be filled with beads or electronics to make the device illuminate and/or vibrate. If filled with fluids such as water, an antibacterial agent such as broponol can be incorporated. The usage of water in the flexible tubular members 300 also allows the device to be microwave and refrigerator safe, facilitating fast heating that other devices in the art that require boiling. Foam filled flexible tubular members 300 are lightweight and have a lighter, softer, easier compression character. The foam filling provides less resistance under compression and thus a lighter penis grip compared to water, which does not compress as easily as the foam.

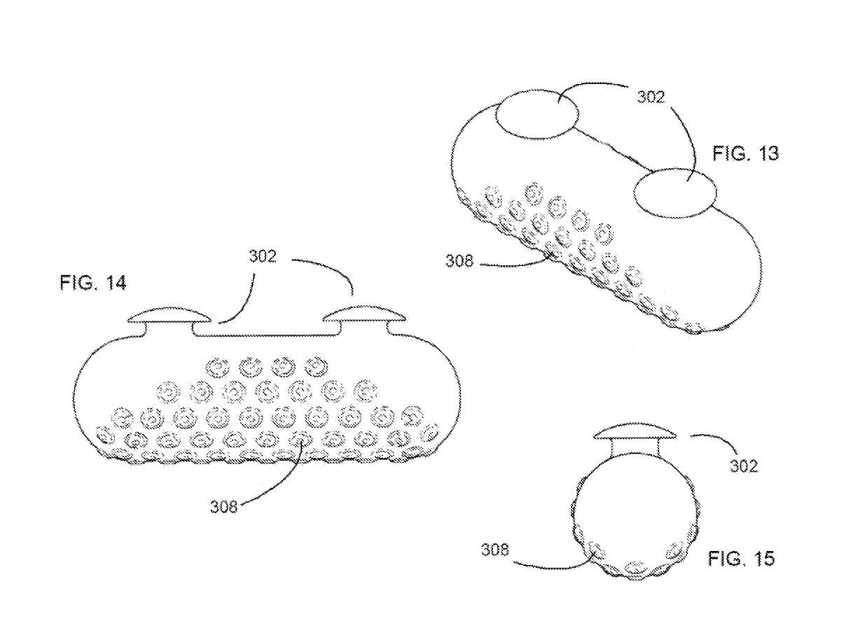

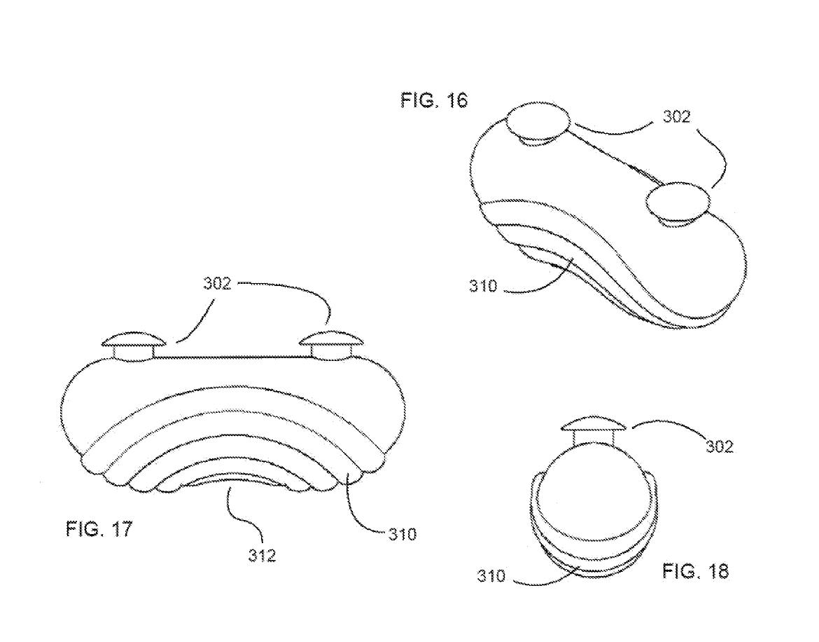

The flexible tubular members 300 facilitate more human-like device control, position, and pressure during use. Also, the cylindrical shape allows for more even expansion of inner materials when compressed and thus even pressure on the penis. The flexible tubular members 300 may comprise various textures and patterns, such as a smooth texture (FIGS. 10-12), bumpy texture (FIGS. 13-15), or ridged texture (FIGS. 16-18). Flexible tubular members 300 with a ridged texture may incorporate a recessed center 312 section to compensate for a higher pressure, as best illustrated in FIG. 17. This recessed center 312 helps to maintain the penis in the center of the device when under excess pressure. Other tube patterns with lower pressures and lower relief textures do not require a recessed center 312 to maintain penis position.

The projections 302 on the flexible tubular members 300 extend distally and terminate in mushroom-shaped ends. The projections 302 retain the flexible tubular members 300 in the holding frame 200 with minimal assembly without adhesives, and disassembly for either cleaning or attaching other tubular member. Also, the mushroom-shaped ends do not interfere with the handgrip during use and further provide a non-slip gripping surface. Since the flexible tubular members 300 are removably attached, they can therefore be interchanged and combined with flexible tubular members 300 comprising various features such as different textures, designs, sizes, or ability to be heated or chilled.

The hand-operated male masturbation device 100 is used by first opening the device. The device is opened by pressing snap closure 202 button and pulling the holding frame 200 apart. The position of the snap closure 202 button allows the holding frame 200 to be released single-handed with one finger. Next, the penis is inserted between the flexible tubular members 300 and the device is closed completely using the snap closure 202, held closed by hand, or held closed using a strap or rubber band around the ball end. The snap closure 202 feature along with its open-ended design allows the device to stay in place hands-free, like a penis ring, however it does not cut off blood flow like a penis ring. Moreover, the open-ended design eliminates the suction force some people dislike on closed-end masturbation devices. Once usage of the device is completed, it may be removed and cleaned with our without disassembly.

All features disclosed in this specification, including any accompanying claim, abstract, and drawings, may be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “step for” performing a specific function, is not to be interpreted as a “means” or “step” clause as specified in 35 U.S.C. §112, paragraph 6. In particular, the use of “step of” in the claims herein is not intended to invoke the provisions of 35 U.S.C. §112, paragraph 6.

Although preferred embodiments of the present invention have been shown and described, various modifications and substitutions may be made thereto without departing from the spirit and scope of the invention. Accordingly, it is to be understood that the present invention has been described by way of illustration and not limitation.

What is claimed:

1. A device for hand-operated male masturbation, the device comprising:
(a) at least one elongated holding frame with a first and second end, and interior and exterior surface, wherein the holding frame is closed when the first end is biased toward the second end; and
(b) at least one flexible tubular member, wherein the flexible tubular member is held in contact with a user's penis by compressing the holding frame.

2. The device of claim 1, wherein the elongated holding frame is a semi-tubular shape with a concaved surface, the concaved surfaces of the semi-tubular holding frame facing one another when the first end is biased toward the second end.

3. The device of claim 1, wherein at least one internal rib is disposed within the interior surface of the holding frame and perpendicular to the holding frames length, maintaining the structural integrity of the holding frame.

4. The device of claim 1, wherein at least one concaved finger recess is disposed on the exterior surface of the holding frame.

5. The device of claim 1, wherein the holding frame concaved sides comprise at least one arch-shaped recess, allowing for expansion of the at least one flexible tubular member when the device is compressed.

6. The device of claim 1, wherein the first and second end of the elongated holding frame can be connected using a snap closure.

7. The device of claim 1, wherein the holding frame comprises at least one hole through its surface, the hole providing a place to attach the at least one flexible tubular member.

8. The device of claim 1, wherein the at least one flexible tubular member is cylindrical in shape with a rounded front and back ends.

9. The device of claim 1, wherein the at least one flexible tubular member is a donut-shaped flexible tube.

10. The device of claim 1, wherein the at least one flexible tubular member comprises at least one projection extending distally from the flexible tubular member, the projection for attaching the flexible tubular member to the holding frame.

11. The device of claim 10, wherein the projection terminates in mushroom-shaped end, retaining the at least one flexible tubular member with projection in the holding frame.

12. The device of claim 1, wherein the at least one flexible tubular member comprises a smooth surface texture.

13. The device of claim 1, wherein the at least one flexible tubular member comprises a bumpy surface texture.

14. The device of claim 1, wherein the at least one flexible tubular member comprises a ridged surface texture.

15. The device of claim 14, wherein the flexible tubular member with ridged surface comprises a recess to maintain the penis in the center of the compressed flexible tubular member.
